(19) United States
(12) Patent Application Publication
(10) Pub. No.: US 2007/0025104 A1
(43) Pub. Date: Feb. 1, 2007

(54) Decorative lamps structure

(76) Inventor: W. T. Chen, Hsinchu (TW)

Correspondence Address: MCGLEW & TUTTLE, PC, P.O. BOX 9227, SCARBOROUGH STATION, SCARBOROUGH, NY, 10510-9227, US

(21) Appl. No.: 11/194,425

(22) Filed: Aug. 1, 2005

(51) Int. Cl. F21V 21/00

(52) U.S. Cl. 362/249

(57) ABSTRACT

A decorative lamps structure having an upper lid and a lower lid. A plurality of refractive bodies in irregular shapes are provided on said lids, and an inside liner is provided in the interior of said lids. A plurality of assembly holes are provided in the proper position of said inside liner for installing illuminant elements, through which the illuminant elements can be directly installed into said assembly holes so that each luminary can be fit in with said inside liner. Therefore, the purpose of providing a simple structure and easy to installation illuminant elements in the present invention can be achieved.

### BACKGROUND OF THE INVENTION

1. Field of the Invention

The present invention relates to a decorative lamps structure, and more particularly to decorative lamps having a simple structure and easy to installation illuminant elements.

2. Description of the Prior Art

Accordingly, the conventional decorative lamps assembly structure, such as disclosed in Taiwan Patent No. 470,145, mainly includes a decorative lamp rack with a plurality of assembly holders provided thereon. Each assembly holder has two cambered pieces facing with each other. The bottom of said cambered pieces is provided with a buckling element. Also, the side of each lamp holder of another lamps string is provided with a pair of clasp responding to said assembly holder, so that said clasp can be buckled with the buckling element. Therefore, each lamp holder can be assembled onto each assembly holder securely.

Even though each lamp holder can be assembled onto each assembly holder securely, so that each luminary can be assembled on each assembly holder when installing illuminant elements onto said lamp holders, however, such conventional decorative lamps assembly structure has many, complicated assembly devices, which makes the fabrication process complicated, inconvenient, and expensive.

### SUMMARY OF THE INVENTION

The present invention has been made based on prior techniques and experiences in fabricating decorative lamps to solve the above-mentioned problems occurred in the prior art.

An object of the present invention is to provide a decorative lamps structure with a simple structure and easy to installation illuminant elements.

According to the above-mentioned object, said decorative lamps structure is provided with an upper lid and a lower lid, on which a plurality of refractive bodies in irregular shapes are provided. The interior of said lids is provided with an inside liner, whereon a plurality of assembly holes are provided in the proper position of said inside liner for installing illuminant elements. During installation, the illuminant elements can be installed into each assembly hole, so that each luminary set can be fit in with said inside liner. Accordingly, the light of said illuminant elements can generate light reflection of snowflakes through refraction of refractive bodies, so that the objective of making the structure simple and illuminant elements easy to be installed can be achieved.

The above purposes, shape, and structure of the present invention will be 41 more apparent from the following detailed description taken in conjunction with the accompanying drawings.

### BRIEF DESCRIPTION OF THE DRAWINGS

FIG. 1 is a three-dimensional external view of the present invention;

FIG. 2 is the second three-dimensional external view of the present invention;

FIG. 3 is a three-dimensional exploded view of the present invention; and

FIG. 4 is a partially enlarged view of the present invention.

### DETAILED DESCRIPTION OF THE PREFERRED EMBODIMENTS

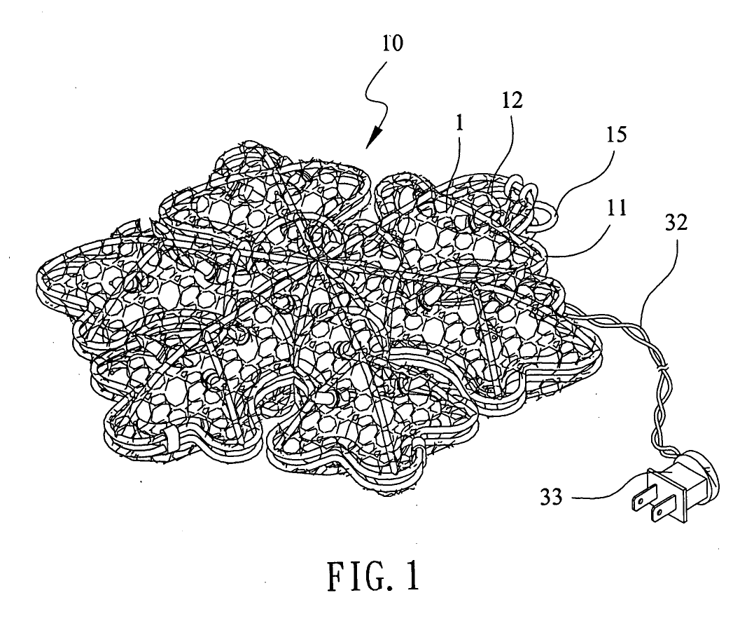

The present invention relates to a decorative lamps structure. Referring to FIGS. 1, 2, 3, and 4, said structure is provided with a brace body 10 having an upper lid 1 and lower lid 2 with symmetry. The upper lid 1 is provided with an upper brace 11 having a plurality of refractive bodies in irregular shapes (or regular shape) covered thereon. Also, an inside liner 13 is provided in the interior of said upper lid 1, and a plurality of assembly holes 14 are provided in the proper position of said inside liner 13 for installing illuminant elements 31.

The lower lid 2 is provided with a lower brace 22 having a plurality of refractive bodies in irregular shapes (or regular shape) covered thereon. Also, an inside liner 23 is provided in the interior of said lower lid 2, and a plurality of assembly holes 24 are provided in the proper position of said inside liner 23 for installing illuminant elements 31. In addition, the fringe of said lower brace 21 is provided with a plurality of clasps 25 (or buckling device), so that when combining said upper lid 1 and lower lid 2, the clasp 25 can be buckled with the fringe of upper brace 11 of said upper lid 1 to secure the assembly of said upper lid 1.

With the assembling of the above-mentioned structure, the illuminant elements 31 can be directly installed into assembly holes 14 and 24, so that each luminary 31 can be fit in with each inside liner 13 and 23. Accordingly, after the upper lid 1 and lower lid 2 are mutually connected, the light of said illuminant elements 31 can be refracted by refractive bodies 12 and 22 to generate light refraction of snowflakes. Therefore, the purpose of providing a simple structure and easy to installation illuminant elements can be achieved.

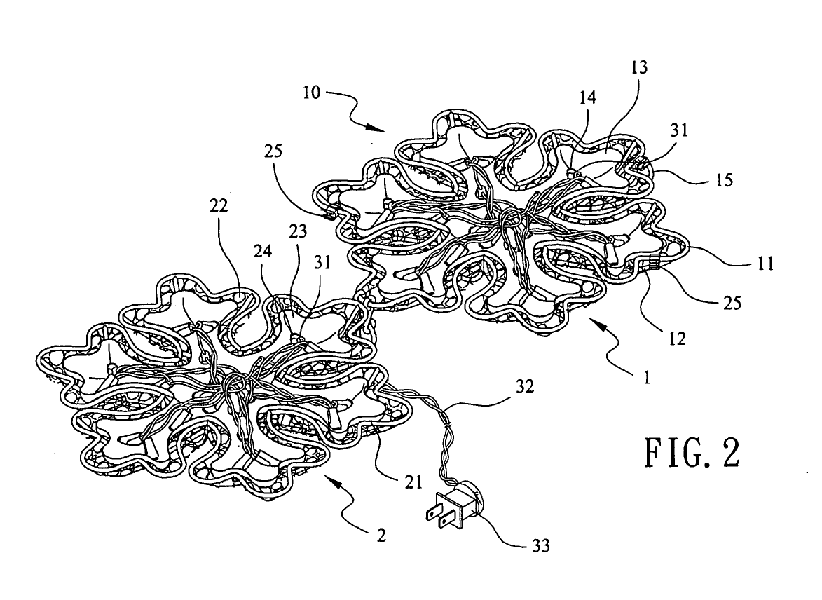

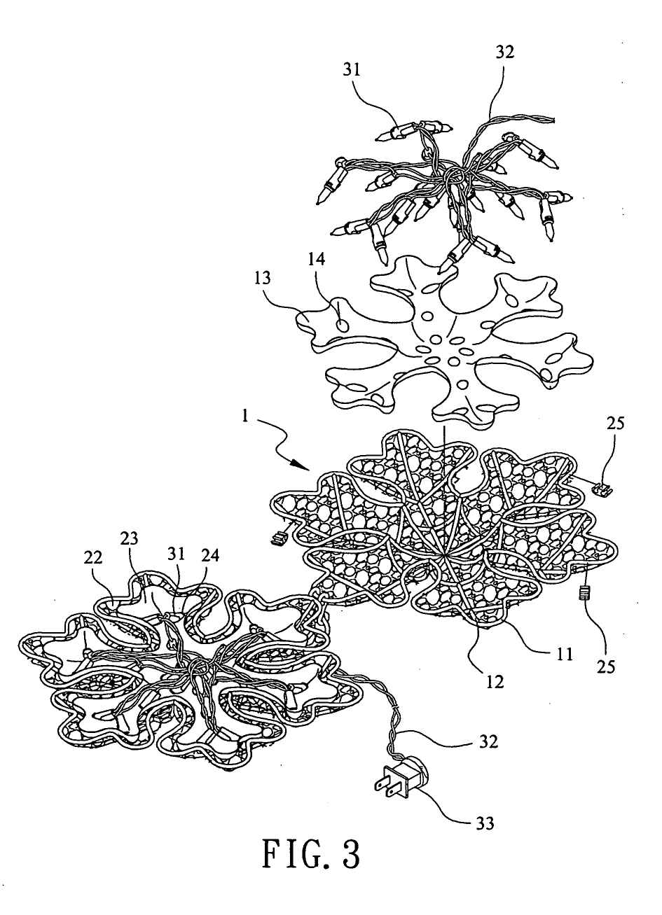

Referring to FIGS. 2 and 3, said illuminant elements 31 are connected as a lamps string set through series, parallel, and series and parallel connection.

Referring to FIGS. 2 and 3, said illuminant elements 31 are made of illuminant devices (i.e., light bulbs, LEDs), a lamp holder, and a lamp base.

Referring to FIGS. 2 and 3, said upper brace 11 and lower brace 21 may be made of a photic material. Said braces are formed and shaped through connecting sub-braces with its fringe.

Referring to FIGS. 2 and 3, said refractive bodies 12 and 22 may be linear-shaped or slice-shaped.

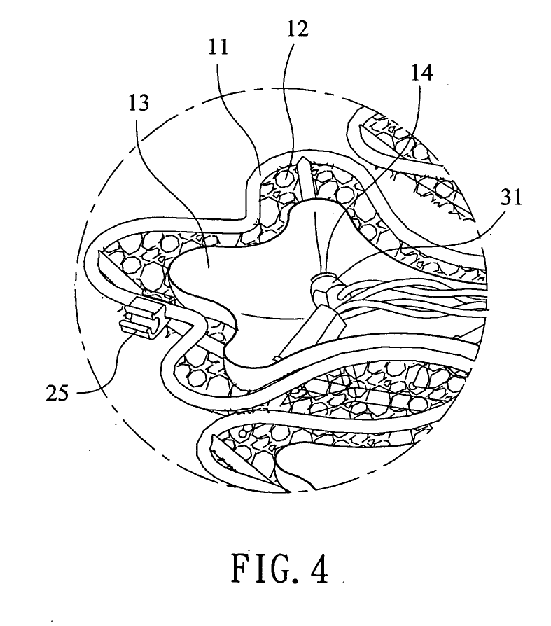

Referring to FIGS. 3 and 4, said illuminant elements 31 may be installed into said assembly holes 14 and 24 in a parallel, inclined, or perpendicular direction.

Referring to FIGS. 1 and 2, said upper lid 1 and lower lid 2 may be shaped in various patterns (i.e. snowflakes) or as written words.

Referring to FIGS. 1, 2, and 3, a fringe of said upper lid 1 is connected with a fringe of said lower lid 2. The fringe of said upper lid 1 is provided with a ring set 15, so that when the upper lid 1 and lower lid 2 are mutually connected, they can be hung by said ring set 15.

Referring to FIGS. 1, 2, and 3, said refractive bodies 12 and 22 and said inside liner 13 and 23 may be made of a photic material or a colored photic material.

Referring to FIGS. 1, 2, and 3, each wire 32 of said illuminant elements 31 can be installed on each inside liner 13 and 23. The end of said wires 32 are extended outwardly, through the side of said upper lid 1 and lower lid 2, to outside of said upper lid 1 and lower lid 2. Said end is provided with a plug 33 for providing power supply for said illuminant elements 31 through connecting said plug 33 with a socket.

As described above, the decorative lamps structure in the present invention certainly has an unprecedented, innovative structure, which is not seen in the conventional decorative lamps. Also, the present invention has not yet been made public, which is consistent with relevant Patent Law.

Although the above-mentioned embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A decorative lamps structure, comprising:
a brace body, which is formed as a predetermined shape by at least two brace kits;
an inside liner, on which a plurality of assembly holes are provided in the proper position for installing illuminant elements; and
a lamps set, including a number of illuminant elements which are fit in with assembly holes on the inside liner;
Said plurality of brace kits, including said inside liner and lamps set, are assembled as a brace body, which forms an illuminant decorative lamps structure.

2. The decorative lamps structure as claimed in claim 1, wherein ring sets are provided in the predetermined part of the fringe of said brace kits, which enables the assembly of said ring sets and brace kits to form a brace body.

3. The decorative lamps structure as claimed in claim 1, wherein a plurality of buckling devices are provided on said brace kits for buckling the fringe of said brace kits with said buckling devices in order to construct the entire brace body.

4. The decorative lamps structure as claimed in claim 1, wherein said brace kits are formed through connecting a plurality of sub-braces with the fringe of said brace kits.

5. The decorative lamps structure as claimed in claim 1, wherein said brace is made of a photic material.

6. The decorative lamps structure as claimed in claim 1, wherein the exterior of said brace is covered by refractive bodies in regular or irregular shapes to display regular or irregular light refraction.

7. The decorative lamps structure as claimed in claim 6, wherein said refractive bodies may be linear-shaped.

8. The decorative lamps structure as claimed in claim 6, wherein said refractive bodies may be slice-shaped.

9. The decorative lamps structure as claimed in claim 6, wherein said refractive bodies may be made of a colored photic material.

10. The decorative lamps structure as claimed in claim 1, wherein said brace body may be shaped in patterns or as written words.

11. The decorative lamps structure as claimed in claim 1, wherein said inside liner may be made of a photic material.

12. The decorative lamps structure as claimed in claim 1, wherein said lamps set are connected as a lamps string set through series, parallel, and series and parallel connection.

13. The decorative lamps structure as claimed in claim 1, wherein said illuminant elements are made of illuminant devices, a lamp holder, and a lamp base.

14. The decorative lamps structure as claimed in claim 1, wherein said illuminant elements are assembled with said inside liner in parallel, inclined, or perpendicular direction.

15. A decorative lamps structure,
comprising:
a brace body, which is formed as a predetermined shape by at least two brace kits;
an inside liner, on which a plurality of assembly holes are provided in the proper position for installing illuminant elements; and
a lamps set, including a number of illuminant elements which are fit in with assembly holes on the inside liner;
Said plurality of brace kits, including said inside liner and lamps set, are assembled as a brace body, which forms an illuminant decorative lamps structure.

16. The decorative lamps structure as claimed in claim 15, wherein ring sets are provided in the predetermined part of the fringe of said brace kits, which enables the assembly of said ring sets and brace kits to form a brace body.

17. The decorative lamps structure as claimed in claim 15, wherein a plurality of buckling devices are provided on said brace kits for buckling the fringe of said brace kits with said buckling devices in order to construct the entire brace body.

18. The decorative lamps structure as claimed in claim 15, wherein said brace kits are formed through connecting a plurality of sub-braces with the fringe of said brace kits.

19. The decorative lamps structure as claimed in claim 15, wherein said brace body is made of a photic material.

20. The decorative lamps structure as claimed in claim 15, wherein the exterior of said brace body is covered by refractive bodies in regular or irregular shapes to display regular or irregular light refraction.

21. The decorative lamps structure as claimed in claim 20, wherein said refractive bodies may be linear-shaped.

22. The decorative lamps structure as claimed in claim 20, wherein said refractive bodies may be slice-shaped.

23. The decorative lamps structure as claimed in claim 20, wherein aid refractive bodies may be made of a colored photic material.

24. The decorative lamps structure as claimed in claim 15, wherein said brace body may be shaped in patterns or as written words.

25. The decorative lamps structure as claimed in claim 15, wherein said inside liner may be made of a photic material.

26. The decorative lamps structure as claimed in claim 15, wherein said lamps set are mutually connected as a lamps string set through series, parallel, and series and parallel connection.

27. The decorative lamps structure as claimed in claim 15, wherein said illuminant elements are made of illuminant devices, a lamp holder, and a lamp base.

28. The decorative lamps structure as claimed in claim 15, wherein said illuminant elements are assembled with said inside liner in parallel, inclined, or perpendicular direction.
